(19) United States
(12) Patent Application Publication
(10) Pub. No.: US 2003/0195766 A1
(43) Pub. Date: Oct. 16, 2003

(54) Method of fundraising for a charitable cause

(76) Inventor: Jean M. Abramson, Brampton (CA)

Correspondence Address: MARKS & CLERK, 350 BURNHAMTHORPE ROAD WEST, SUITE 402, MISSISSAUGA, ON, L5B 3J1, CA

(21) Appl. No.: 10/428,119

(22) Filed: May 2, 2003

Related U.S. Application Data
(63) Continuation-in-part of application No. 09/516,243, filed on Mar. 1, 2000, now abandoned.

(51) Int. Cl. B32B 1/02

(52) U.S. Cl. 705/1; 428/35.7

(57) ABSTRACT

Money is raised for a single and specific charitable cause or non-profit organization by selling decorative ornaments which comprise a translucent container—usually, a clear spherical object such as a Christmas tree ornament—and placing inside it a specific logo, indicium, or inspirational or motivational slogan, which is identified with that single and specific charitable cause or non-profit organization. The net proceeds obtained from selling the decorative ornaments having in their interior a specific logo, indicium, or inspirational or motivational slogan, for the specific charitable cause or non-profit organization are then turned over to that charitable cause or non-profit organization. Thus, a long lasting and relatively valuable ornament is exchanged for a gift of money to a specific charitable cause or non-profit organization, and the logo, indicium, or inspirational or motivational slogan is prominently displayed within the decorative ornament, but does not comprise the ornament itself.

### CROSS-RELATED APPLICATION

This application is a continuation-in-part of U.S. patent application Ser. No. 09/516,243 filed Mar. 1, 2000 for “Method of Fundraising for a Charitable Cause” now abandoned.

### FIELD OF THE INVENTION

This invention relates to methods for raising money for charitable causes and other non-profit organizations. A means and method by which money may be raised for any specific charitable cause or non-profit organization, by the sale of decorative ornaments which are translucent and which have placed inside them a logo or other indicum, or inspirational or motivational slogan, with which the specific charitable cause or non-profit organization is readily identified, is provided hereby.

### BACKGROUND OF THE INVENTION

There are, of course, many known ways for raising money for charitable causes. Not the least of them is the United Way campaign which is usually carried out in the autumn, and which comprises door-to-door and business-to-business solicitations and the taking of pledges. Other pledge taking campaigns to raise funds are carried out, for example, by public broadcasting radio stations and television networks, appeals over radio and television and in newspapers for college support and scholarship funds, and so on.

Another popular way for raising money for charitable causes or other non-profit organizations which support charities or provide charitable and/or social services to their community, is to sell items or specific goods, which may be identified with the particular charitable cause or non-profit organization for which money is being raised. For example, poppies are sold in October and the beginning of November to raise money for various veterans associations; daffodils are sold in the spring time of the year to raise money for cancer research; teddy bears are sold to raise money for children's hospitals, and so on. A particular manner for raising money for any particular charitable cause might be to sell ribbons of various colors: Pink for breast cancer research, red for AIDS research, white in support of women's shelters, and/or charitable societies which raise public awareness of violence against women, and so on. Non-profit organizations may also be identified by a particular logo, indicium, or inspirational or motivational slogan, or they may seek to adopt an inspirational or motivational slogan, in association with which they may raise money for their own work—such as hospices, food banks, and the like.

Yet another method of fundraising was taught in an undated article “Decorate a Holiday Tree” from the website www.wcul.org/Media/CMN/fundrais.html. The article teaches that a single Christmas tree was to be decorated in a community Credit Union branch office by the staff of that office. Each member of the staff could select an ornament, none of which was the same as any other ornament, and then place the chosen ornament on a common community tree together with all of the other ornaments bought by other staff members of the same Credit Union. Each donation was personalized by virtue of having the staff member sign a holiday card to signify that he or she has made a donation.

A further method of making donations was taught in a Dec. 14, 1999 article “United Way offers Links to Gift-Giving Programs” published by the Madison Newspapers Inc. In that article, a community Christmas tree at a local bank was said to have been decorated by heart-shaped tags featuring the name of an individual family or a teenager who is likely to be without presents during Christmas time. To make a donation, donors chose a tag and then bought a present for the person named on the tag. Thus, it could be considered that the Christmas tree became undecorated as the tags are removed from the tree.

It is apparent from the first reference that by making a donation, each donor is reciprocated with and identified by a distinct Christmas ornament which is different from any other Christmas ornament received from any other donor. The donor had the opportunity to choose that distinct Christmas ornament from a plurality of different Christmas ornaments which he or she wanted to place on the community Christmas tree. The donor was recognized after he or she made a donation.

In the latter reference, each donor picked a tag which was different from any other tags on the community Christmas tree. It is apparent that the donor making the donation was to buy a Christmas present which would have been tailored for the particular individual or family whose name was featured on the tag chosen by the donor.

Finally, in U.S. Pat. No. 4,968,565 issued to STEFANO on Nov. 6, 1990, a personalized ornament for a Christmas tree is taught. The ornament is to be hung on a Christmas tree or elsewhere. A personalizing element is adapted to receive within a transparent tubular portion and is such that the personalizing element can be viewed through the transparent portion. The personalizing element could be photographs, drawings, personal messages, a toy or other memorabilia having special meaning to the respective user. Thus, the personalized ornament as taught by STEFANO provides a Christmas tree ornament that is quite distinct from any other Christmas tree ornament by virtue of the fact of the personalizing element contained in the personalized ornament.

It will be apparent from the foregoing prior art that any element placed on a Christmas tree, whether it is an ornament or a tag, is distinct from any other ornaments or tags on that Christmas tree. Further, as is apparent from the teachings of the STEFANO patent, that each ornament is personalized, such that each ornament gives a special meaning to the respective user.

### SUMMARY OF THE INVENTION

It is an object of the present invention to provide a novel method of fundraising for a charitable cause which obviates or mitigates the disadvantages of the prior art, and which is directed in an opposed direction so as to be the antithesis of the prior art.

In accordance with one aspect of the present invention, a method of raising money in any one campaign for a single and specific charitable cause or non-profit organization is taught, where the charitable cause or non-profit organization has a well-known logo, indicium, or inspirational or motivational slogan, by which it is readily identified. The method comprises the steps of:

(a) Obtaining a plurality of translucent, hollow, lightweight containers. Each such translucent, hollow, light weight container has an opening into which a mounting device or other stabilizing or attachment device may be inserted, and over which a cap is placed, so as to enable the translucent, hollow, lightweight container to be suspended from or placed on a supporting display element as a decorative ornament.

(b) Obtaining a plurality of specific logos, indicia, or inspirational or motivational slogans, where each of the specific logos, indicia, or inspirational or motivational slogans, is one which is used by the single and specific charitable cause or non-profit organization so as to identify that specific charitable cause or non-profit organization. Each individual logo, indicium, or inspirational or motivational slogan is identical to each other individual logo, indicium, or inspirational or motivational slogan for that particular campaign for that single and specific charitable cause or non-profit organization; and each individual logo, indicium, or inspirational or motivational slogan is mutually exclusive from any other individual logo, indicium, or inspirational or motivational slogan used for another single and specific charitable cause or non-profit organization. In any event, each individual but identical logo, indicium, or inspirational or motivational slogan, is of a size and flexibility that permits it to be passed through the opening of a lightweight container and to placed entirely within the light weight container, whereby the specific logo, indicium, or inspirational or motivational slogan, can be easily recognized as being the logo, indicium, or inspirational or motivational slogan, associated with that single and specific charitable cause or non-profit organization on whose behalf the fundraising campaign is being conducted.

(c) A single such logo, indicium, or inspirational or motivational slogan, is placed in each translucent, hollow, lightweight container, by passing the same through the opening of the container. Also, the mounting device or other stabilizing or attachment device for the lightweight container is placed in the opening thereof, and the cap is put into place over the opening of the translucent, hollow, light weight container, so as to thereby form a decorative ornament.

(d) Each decorative ornament is then exchanged with a donor for an amount of money or a pledge of money which is greater than the cost of the materials thereof, and the cost of the labor for assembling the same.

(e) Finally, all of the net proceeds from the exchange of the decorative ornaments with respective donors are turned over to the single and specific charitable cause or non-profit organization for whom the fundraising campaign was conducted.

Typically, the mounting device is chosen from the group consisting of hanger devices, stabilizing devices and attachment devices. In one embodiment, the opening of the lightweight container is an open neck.

The translucent, hollow, lightweight container has a specific configuration which, itself, is associated with a particular charitable cause or non-profit organization. In a particular embodiment of the present invention, the translucent, hollow, lightweight container is spherical in shape, the opening is an open neck and the mounting device is a hanger device, whereby the decorative ornament is adapted for use as a Christmas tree ornament.

The logo, indicium, or inspirational or motivational slogan, which is placed in the translucent, hollow, lightweight container may be a ribbon having a specific color which is identified which a particular charitable cause or non-profit organization. The logo may be formed of paper or cloth having a particular or specific configuration; it may also have a particular or specific color, or it may be simply printed on paper or cloth.

In a particular embodiment of the present invention, the translucent, hollow, lightweight container is clear and colourless. In other embodiments of the present invention, the translucent, hollow, light weight container may have a discernible colour, but it is sufficiently translucent that the logo, indicium, or inspirational or motivational slogan, which is placed within the container is readily identifiable.

It is contemplated that the method of fundraising for a charitable cause of the present invention is particularly useful for providing the donor of money with a tangible, useful, and long-lasting reminder, by way of a decorative ornament, of the support being given by that donor of the specific charitable cause or non-profit organization being supported.

### BRIEF DESCRIPTION OF THE DRAWINGS

The novel features which are believed to be characteristic of the present invention, as to its structure, organization, use and method of operation, together with further objectives and advantages thereof, will be better understood from the following drawing in which a presently preferred embodiment of the invention will now be illustrated by way of example. It is expressly understood, however, that the drawing is for the purpose of illustration and description only and is not intended as a definition of the limits of the invention. Embodiments of this invention will now be described by way of example in association with the accompanying drawing in which:

FIG. 1 is an exploded diagram showing the manner of assembly of a typical decorative ornament in keeping with the present invention.

### DETAILED DESCRIPTION OF THE PREFERRED EMBODIMENTS

Throughout this disclosure, and in the appended claims, use of the words “sell”, “selling”, “sale”, and other variations thereof, is meant to convey the meaning of goods changing hands as part of or as an ancillary transaction to money changing hands, or the pledge of money changing hands, in the opposite direction.

For example, fund raising for veterans associations and the like, which occurs in October and November of each year, encompasses the provision and wearing of poppies, whereby a donor to the campaign is identified by the fact that he or she is wearing a poppy. However, in quite technical terms, the poppy has not been “sold”; rather, it has been given to the donor as a form of receipt, acknowledging a gift of money from that donor. Accordingly, no “sale” has technically been made, and there are no implications of “sales tax” being paid, vendors' licences being required, and so on. Thus, in the vernacular, a donor may be heard to say that he or she “bought” a poppy, while it is understood both by the donor and anyone to whom the donor is speaking that, in fact, a “sale” in the technical sense did not take place, even though it accompanied the exchange of money from hand to hand. It is in that context that the words “sale”, “selling” or “sold” or variations thereof, are used in this disclosure and in the accompanying claims.

The present invention provides a means and method for raising money for any single and charitable cause and other non-profit organization, in return for which decorative ornaments having in their interior the specific logo, indicium, or slogan, associated with and thereby identifying that single and specific charitable cause or non-profit organization are exchanged between the single and specific charitable cause or non-profit organization and the donors of money thereto. The specific appearance of the decorative ornament can vary depending on the charitable cause or non-profit organization for which money is being raised; it being understood that similar containers or “baubles” can be used for differing charitable causes or non-profit organizations by inserting differing logos, indicia, or slogans, therein. Thus, the present invention provides the donor of money with a tangible, useful, and long-lasting reminder, by way of a decorative ornament, of the support being given by that donor to the single and specific charitable cause or non-profit organization being supported.

In particular, the present invention seeks to provide a method for raising money for single and specific charitable causes and non-profit organizations, by providing decorative ornaments such as Christmas tree ornaments, or the like, in return for a gift or pledge of money. In each such transaction, each decorative ornament has had placed therein a specific logo, indicium, or inspirational or motivational slogan, which readily identifies the single and specific charitable cause or non-profit organization being supported.

Accordingly, the present invention provides a method which comprises several steps, identified as follows:

(a) Obtaining a plurality of translucent, hollow, lightweight containers. Each such translucent, hollow, light weight container has an opening into which a mounting device or other stabilizing or attachment device may be inserted, and over which a cap is placed, so as to enable the translucent, hollow, lightweight container to be suspended from or placed on a supporting display element as a decorative ornament.

(b) Obtaining a plurality of specific logos, indicia, or inspirational or motivational slogans, where each of the specific logos, indicia, or inspirational or motivational slogans, is one which is used by the single and specific charitable cause or non-profit organization so as to identify that specific charitable cause or non-profit organization. Each individual logo, indicium, or inspirational or motivational slogan is identical to each other individual logo, indicium, or inspirational or motivational slogan for that particular campaign for that single and specific charitable cause or non-profit organization; and each individual logo, indicium, or inspirational or motivational slogan is mutually exclusive from any other individual logo, indicium, or inspirational or motivational slogan used for another single and specific charitable cause or non-profit organization. In any event, each individual but identical logo, indicium, or inspirational or motivational slogan, is of a size and flexibility that permits it to be passed through the opening of a lightweight container and to placed entirely within the light weight container, whereby the specific logo, indicium, or inspirational or motivational slogan, can be easily recognized as being the logo, indicium, or inspirational or motivational slogan, associated with that single and specific charitable cause or non-profit organization on whose behalf the fundraising campaign is being conducted.

(c) A single such logo, indicium, or inspirational or motivational slogan, is placed in each translucent, hollow, lightweight container, by passing the same through the opening of the container. Also, the mounting device or other stabilizing or attachment device for the lightweight container is placed in the opening thereof, and the cap is put into place over the opening of the translucent, hollow, light weight container, so as to thereby form a decorative ornament.

(d) Each decorative ornament is then exchanged with a donor for an amount of money or a pledge of money which is greater than the cost of the materials thereof, and the cost of the labor for assembling the same.

(e) Finally, all of the net proceeds from the exchange of the decorative ornaments with respective donors are turned over to the single and specific charitable cause or non-profit organization for whom the fundraising campaign was conducted.

In keeping with a principal criteria of the present invention, each decorative ornament which is exchanged with a donor for an amount of money or for a pledge of money in any one campaign from single and specific charitable cause or non-profit organization is identical to each other decorative ornament which is exchanged with another donor for an amount of money or for a pledge of money in that same campaign. Thus, there is nothing that distinguishes one ornament from another, and the ornament is one of many mass-produced ornaments specific to that particular campaign for that particular single and specific charitable cause or non-profit organization.

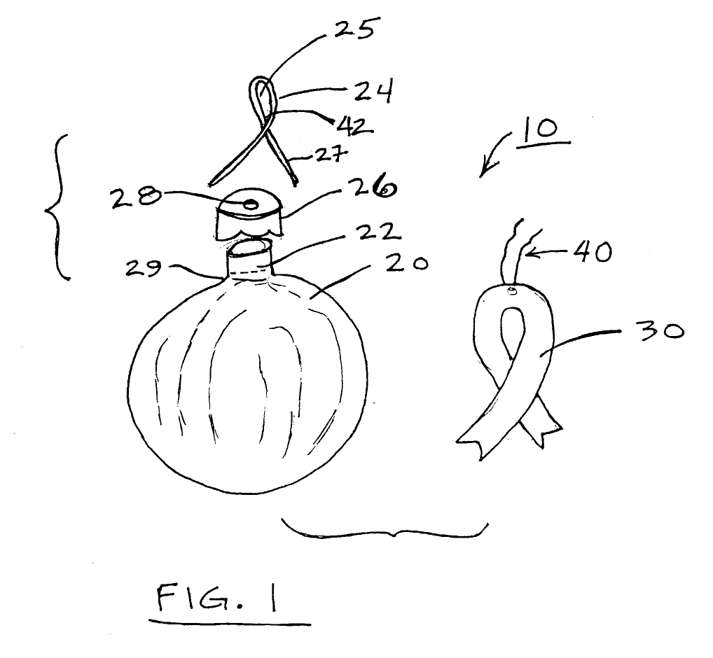

Having regard to FIG. 1, a typical decorative ornament which is of the sort which might commonly be employed as a Christmas tree ornament is shown. However, it will be seen that the object illustrated in FIG. 1 is not a typical Christmas tree ornament or the like, because it has placed inside it a specific logo, indicium, or inspirational or motivational slogan, by which a single and specific charitable cause or non-profit organization is readily identified. Accordingly, the container or bauble within which the specific logo, indicium, or inspirational or motivational slogan is placed, is translucent, and may generally be clear or colorless. Such Christmas tree ornaments in keeping with the present invention have been distributed under the name of Charity Ball™, for the purposes of raising money on behalf of breast cancer research.

Typically, the decorative ornament 10 comprises a translucent, hollow, light weight container 20 which has an open neck 22 into which a hanger device 24 is inserted. A cap 26 is placed over the end of the open neck 22.

Usually, the assembly of the ornament 10, if it is a typical Christmas tree ornament, for example, simply comprises placing the hanger device 24 by squeezing the legs 27 thereof and placing them through the hole 28 formed in the cap 26, and then placing the assembled hanger device and cap over the open neck 22 so that the legs 27 of the hanger device are permitted to expand one again and the interfere with the base of the neck 22 at 29.

Typically, a hook is passed through the opening 25, whereby the ornament maybe suspended from a branch of a Christmas tree, for example.

The present invention provides, however, for the placement of a logo, indicium, or inspirational or motivational slogan, such as that which is shown at 30 in FIG. 1, into the interior of the container 20. Accordingly, the logo, indicium, or inspirational or motivational slogan 30 must be sufficiently flexible so as to pass through the open neck 22 of the container 20, whereupon it will recover its original configuration. Of course, the logo, indicium, or inspirational or motivational slogan 30 must also be of a size which will fit entirely within the container 20.

Typically, the logo, indicium, or inspirational or motivational slogan 30 may be secured in place by such as a thread 40 which is tied in place at the vertex 42 beneath the loop 25 of the hanger device 24.

It will now be seen that any logo, indicium, or inspirational or motivational slogan 30 may be placed into a container 20 which is light weight, hollow, and translucent, in order that the logo, indicium, or inspirational or motivational slogan 30 may be seen when it is in place in the interior of container 20. Thereafter, the sale of the assembled decorative ornaments that are thus achieved may be conducted, whereby the net proceeds of such sales, after deducting the cost of the materials being used and the labor for the assembly of the decorative ornaments, will then be turned over to the charitable cause or non-profit organization for its own use at its own discretion.

Moreover, it will be understood that the decorative ornament may not necessarily be one which is suspended such as from the branch of a Christmas tree. Thus, the hanger device 24 may more generally be referred to as a mounting device, which might be a hanger device or some other form of stabilizing device or other attachment device, whereby the decorative ornament may be suspended from or placed on a supporting display element such as the branch of a Christmas tree, a supporting base, a plaque, or the like.

As noted above, such sale of decorative ornaments provides an item of value to the donor, and a lasting reminder of the commitment by that donor to the specific charitable cause or non-profit organization being supported and which is identified by the specific logo, indicium, or inspirational or motivational slogan 30 within the container 20.

Of course, it is possible that the shape or configuration of the translucent, hollow, light weight container 20 may be other than spherical. A particular example might be containers which have substantially flat front and back faces, and which have a configuration such as that of a Star of David, whereby a variety of Jewish charitable causes or non-profit organizations might be supported. Other examples of specific configurations of container might include those of a whale or panda bear, such as those used by various ecological societies and charitable causes or non-profit organizations, the shape of a famous building such as St. Paul's Cathedral in London, England, used for ongoing fundraising for continuing maintenance and upkeep of such an historic building, and so on. The flag or banner or each specific charitable cause is then inserted into a respective container, so as to be visible by any observer thereof.

Moreover, it will be understood that the decorative ornament may not necessarily be one which is suspended such as from the branch of a Christmas tree. Thus, the hanger device 24 may more generally be referred to as a mounting device, which might be a hanger device or some other form of stabilizing device or other attachment device, whereby the decorative ornament may be suspended from or placed on a supporting display element such as the branch of a Christmas tree, a supporting base, a plaque, or the like

As previously noted, where the logo, indicium, or inspirational or motivational slogan, is a ribbon such as that particularly indicated in FIG. 1, the ribbon may have a specific color identified with a particular charitable cause. For example, a pink ribbon is identified with breast cancer research; a red ribbon indicates support for AIDS research; and so on.

Also, the logo, indicium, or inspirational or motivational slogan, might be formed of paper or cloth having a particular or specific configuration which might be identified with a particular charitable cause or non-profit organization. Again, such an example might include a configuration of a whale or panda bear as used by ecological groups, a Torah such as that used by the United Jewish Appeal, and so on. Still further, the logo, indicium, or inspirational or motivational slogan, might have a particular color; again, a representation of a pink ribbon printed on paper or cloth is a typical example.

Typically, the translucent, hollow, light weight container 20 is clear and colorless, so that the logo, indicium, or inspirational or motivational slogan 30, and particularly its color or other representative or specific features, may be easily recognized.

On the other hand, the translucent, hollow, light weight container may have a discernible colour—for example, light blue might be used by a variety of Jewish charitable causes or non-profit organizations, light yellow might be used by cancer societies, light pink or red might be used by heart associations, and so on.

In any and all events, it will be seen that the present invention provides a means and method by which money may be raised for any specific charitable cause or non-profit organization, provided that that charitable cause or non-profit organization has a well-known logo, indicium, or inspirational or motivational slogan, by which it is identified.

Obviously, therefore, any specific and/or particular charitable cause or non-profit organization is not excluded from taking advantage of the present invention, provided that they do indeed have a well-known logo, indicium, or inspirational or motivational slogan, by which they are identified. In any event, the donor receives an item of value, and the charitable cause or non-profit organization has raised money using a method and providing a lasting memento to each donor or patron, in a manner heretofore unknown.

Thus, the present invention provides a method to sell or exchange such decorative ornaments with as many individuals as possible, each of whom would then use the decorative ornament for his or her own purposes. As indicated above, typically, those purposes are, indeed, as a Christmas tree ornament, but not necessarily. Typically, and indeed it is expected, any individual person who exchanges a gift or pledge of money for a decorative ornament is unaware of any other person having done the same thing. The exchange of decorative ornaments for money or pledges of money, the net proceeds of which are given to a single and specific charitable cause or non-profit organization, is essentially anonymous as to each individual whose money or pledge of money has been collected.

It could well be that the same individual donor could be approached on behalf of different specific charitable causes or non-profit organizations, to purchase decorative ornaments which would, however, be different one from another by virtue of the fact that they would at least have therein a different specific logo, indicium, or inspirational or motivational slogan than those which are being exchanged for money or pledges of money on behalf of another charitable cause or non-profit organization. But for any specific charitable cause or non-profit organization, all of the decorative ornaments would have the same appearance, they are not in any way personalized, and the ownership of them is anonymous.

For instance, Donor A or Donor B may each purchase identical ornaments, take them to their respective homes, and display them if they wish in their respective homes in any manner they deem fit. If Donor A visits the home of Donor B and sees the same ornament, then Donor A knows that Donor B has supported the same charitable cause or non-profit organization that Donor A has. If Donor C were to visit each of Donor A and Donor B, and recognize the logo, indicium, or slogan in the decorative ornaments that Donor C would see in the respective homes of Donor A and Donor B, then Donor C would know that each of Donor A and Donor B support a specific charitable cause or non-profit organization, even if Donor C did not support that specific charitable cause or non-profit organization.

It is noted that the decorative ornament of the present invention is in an assembled condition before it is advertised or displayed for the fundraising campaign. The specific logo, indicium, or inspirational or motivational slogan, has already been placed inside the container, and thus, the donor receiving the Christmas ornament does not need to put the pieces of the ornament together.

While only specific combinations of various features and components of the present invention have been discussed herein, it will be apparent to those skilled in the art that desired subsets of the disclosed features and components and/or alternative combinations of these features and components can be utilized, as desired.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

What is claimed is:

1. A method of raising money in any one campaign for a single and specific charitable cause or non-profit organization, where the charitable cause or non-profit organization has a well-known logo, indicium, or inspirational or motivational slogan, by which it is readily identified, said method comprising the steps of:
(a) Obtaining a plurality of translucent, hollow, lightweight containers, each having an opening into which a mounting device is inserted, and over which a cap is placed, so as to enable each lightweight container to be suspended from or placed on a supporting display element as a decorative ornament;
(b) Obtaining a plurality of specific logos, indicia, or inspirational or motivational slogans, for a single and specific charitable cause or non-profit organization, where each individual logo, indicium, or inspirational or motivational slogan is identical to each other individual logo, indicium, or inspirational or motivational slogan for that particular campaign for that single and specific charitable cause or non-profit organization, and each individual logo, indicium, or inspirational or motivational slogan is mutually exclusive from any other individual logo, indicium, or inspirational or motivational slogan used for another single and specific charitable cause or non-profit organization, and where each of said individual logo, indicium, or inspirational or motivational slogan, is of a size and flexibility so as to permit it to be passed through the opening of the lightweight container and to be placed entirely therewithin whereby it can be easily recognized as being the logo, indicium, or inspirational or motivational slogan, associated with that single and specific charitable cause or non-profit organization on whose behalf the fundraising campaign is being conducted;
(c) Placing a single logo, indicium, or inspirational or motivational slogan, for a single and specific charitable cause or non-profit organization in each translucent, hollow, lightweight container by passing the same through the opening of the lightweight container, placing the mounting device for a lightweight container in the opening thereof, and putting the cap in place over the opening, so as to thereby form a decorative ornament;
(d) Exchanging each decorative ornament with a donor for an amount of money or for a pledge of money in an amount which is greater than the cost of the materials of the decorative ornament and the cost of labor for assembling the same; and
(e) Turning over all of the net proceeds from the exchange of the decorative ornaments with donors to the single and specific charitable cause or non-profit organization for whom the fundraising campaign was conducted.

2. The method of raising money for a single and specific charitable cause or non-profit organization as described in claim 1, where said mounting device is chosen from the group consisting of hanger devices, stabilizing devices and attachment devices.

3. The method of raising money for a single and specific charitable cause or non-profit organization as described in claim 1, where said opening of said lightweight container is an open neck.

4. The method of raising money for a single and specific charitable cause or non-profit organization as described in claim 1, where said translucent, hollow, lightweight container is spherical in shape, said opening is an open neck, and said mounting device is a hanger device, whereby said decorative ornament is adapted for use as a Christmas tree ornament.

5. The method of raising money for a single and specific charitable cause or non-profit organization as described in claim 1, where said translucent, hollow, lightweight container has a specific configuration which, itself, is associated with a particular charitable cause or non-profit organization.

6. The method of raising money for a single and specific charitable cause or non-profit organization as described in claim 1, where the logo, indicium, or inspirational or motivational slogan, which is placed in each translucent, hollow, light weight container is a ribbon having a specific colour identified with a particular charitable cause or non-profit organization.

7. The method of raising money for a single and specific charitable cause or non-profit organization as described in claim 1, where the logo, indicium, or inspirational or motivational slogan, which is placed in each translucent, hollow, lightweight container is formed of paper or cloth having a particular and specific configuration, such as to be identified with a particular charitable cause or non-profit organization.

8. The method of raising money for a single and specific charitable cause or non-profit organization as described in claim 7, where the logo, indicium, or inspirational or motivational slogan, which is placed in each translucent, hollow, light weight container also has a specific colour.

9. The method of raising money for a single and specific charitable cause or non-profit organization as described in claim 1, where the logo, indicium, or inspirational or motivational slogan, which is placed in each translucent, hollow, light weight container is printed on paper or cloth.

10. The method of raising money for a single and specific charitable cause or non-profit organization as described in claim 1, where the translucent, hollow, lightweight container is clear and colorless.

11. The method of raising money for a single and specific charitable cause or non-profit organization as described in claim 1, where the translucent, hollow, lightweight container has a discernable color, but is sufficiently translucent that the logo, indicium, or inspirational or motivational slogan, placed therewithin is readily identifiable.
